(19) United States
(12) Patent Application Publication
(10) Pub. No.: US 2004/0135541 A1
(43) Pub. Date: Jul. 15, 2004

(54) Battery charger for mobile phone

(75) Inventors: Yun Cho, Suwon-shi (KR); Seung-Woo Lim, Seoul (KR); Jung-Nam Moon, Seoul (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/667,811

(22) Filed: Sep. 22, 2003

(30) Foreign Application Priority Data
Jan. 9, 2003 (KR) 2003-01453

(51) Int. Cl. H02J 7/00

(52) U.S. Cl. 320/107

(57) ABSTRACT

Disclosed is a battery charger for a mobile phone, with a slot of which the front part is opened. The battery charger in accordance with the present invention comprises a first slot having an opening at the front part thereof and being surrounded by a first inside wall and a first battery pack-supporting surface, and a second slot having an opening at the front part thereof, which is a part facing the first slot, and being surrounded by a second inside wall and a second battery pack supporting surface.

### PRIORITY

This application claims priority to an application entitled “BATTERY CHARGER FOR MOBILE PHONE”, filed in the Korean Industrial Property Office on Jan. 9, 2003 and assigned Serial No. 2003-01453, the contents of which are hereby incorporated by reference.

### BACKGROUND OF THE INVENTION

1. Field of the Invention

The present invention relates to a battery charger for a mobile phone, and more particularly to a battery charger for a mobile phone having a slot of which a front part is opened, thereby providing for simultaneously charging a battery pack combined with a mobile phone and a reserve battery pack.

2. Description of the Related Art

Generally, a mobile phone operates by being combined with a battery pack detachably attached thereto, and such a battery pack is typically rechargeable by use of a battery charger. Such a battery pack can be charged either separate from a mobile phone or in combination with a mobile phone. There are one-slot-type battery chargers having only one slot for receiving only a battery pack and a two-slot type battery charger having two slots for receiving two battery packs.

FIG. 1A illustrates a perspective view of a one-slot type battery charger in accordance with the conventional art, and FIG. 1B illustrates a cross-sectional side view of the one-slot type battery charger shown in FIG. 1A. Referring to FIG. 1A and FIG. 1B, a one-slot type battery charger in accordance with the conventional art comprises a body being comprised of an upper case 2 and a lower case 3, a slot 6 provided on a part of the upper case 2 for receiving a battery pack 5 therein, combined with a mobile phone 4, electrical connection terminals 7 provided in the slot 6 to be connected with electrical connection terminals (not shown) provided at the rear part of the battery pack 5, and a printed circuit board 8 for grounding the electrical connection terminals 7. Here, since the battery pack 5 can be used only for a predetermined short period of time, the user of such a mobile phone always must carry a charged additional battery pack or a reserve battery pack.

The one-slot-type battery charger is disadvantageous in that it can charge only a battery pack when combined with a mobile phone. Accordingly, in the case of charging a reserve battery pack, the reserve battery pack is required to be combined with the mobile phone. Therefore, charging such a battery pack is inconvenient.

FIG. 2A illustrates a perspective view of a two-slot type battery charger in accordance with the conventional art and FIG. 2B illustrates a cross-sectional side view of the two-slot type battery charger shown in FIG. 2A. Referring to FIGS. 2A and 2B, a two-slot type battery charger in accordance with the conventional art comprises a body 10 being comprised of an upper case 11 and a lower case 12, two slots 70, 80 provided at corresponding portions of the upper case 11, a plurality of electrical connection terminals 50, 51 provided in the slots 70, 80 to be electrically connected with electrical connection terminals (not shown) provided at the back surface of battery packs 20, 30, and a printed circuit board 60 for grounding the electrical connection terminals 50, 51.

The upper case 11 has a first slot 70 for receiving a battery pack 30 combined with a mobile phone 40, and a second slot 80 for receiving a reserve battery pack 20 separated from the mobile phone 40. The first slot 70 and the second slot 80 are separated from each other by a partition 93 interposed therebetween. The electrical connection terminals 50, 51 are projected in the respective slots 70, 80. Further, the upper case 11 has at least one lamp 90 for indicating completion of the charging operation. Further, tension bars 91 are provided in the first slot 70 for safely receiving the battery pack 40 combined with the mobile phone 30 in the first slot 70 and fixing them therein. Each tension bar 91 has a fixing portion 92 to be combined with a groove 41 formed on a side surface of the mobile phone 40. The two-slot type battery charger in accordance with the conventional art is disadvantageous in that the first slot for charging the battery pack combined with the mobile phone therein and the second slot for charging the reserve battery pack separated from the mobile phone are separated from each other by the partition, so that the structure of the battery charger is complicated. Since the structure of the battery charger case is complicated, it is difficult to fabricate a mold for producing such complicated battery charger cases. Further, it is difficult to miniaturize a battery charger because the upper case of the battery charger has to be of a size large enough to form two slots thereon, so the an appearance of the battery charger is not good.

### SUMMARY OF THE INVENTION

Therefore, the present invention has been made in view of the above problem, and it is an object of the present invention to provide a battery charger for a mobile phone, which has a slot with an opening at the front part thereof and a locking device which enables a battery pack combined with a mobile phone and a reserve battery pack separated from a mobile phone to be simultaneously charged, so that different sizes of battery packs can be simultaneously charged using the battery charger in accordance with the present invention.

It is another object of the present invention to provide a battery charger for a mobile phone, which has a slot with an opening at the front part thereof and a locking device which enables a battery pack combined with a mobile phone and a reserve battery pack separated from a mobile phone to be simultaneously charged, so that fabrication of the battery charger becomes easier.

It is yet another object of the present invention to provide a battery charger for a mobile phone, which has a slot with an opening at the front part thereof and a locking device, which enables a battery pack combined with a mobile phone and a reserve battery pack separated from a mobile phone to be simultaneously charged, so that a battery charger has a smaller size and a good appearance.

In accordance with the present invention, the above and other objects can be accomplished by the provision of a battery charger for a mobile phone, with at least one slot for receiving and charging at least one battery pack therein, and at least one charging terminal, comprising a first slot having an opening at a front part thereof and being surrounded by a first inside wall and a first battery pack supporting surface, and a second slot having an opening at a front part thereof, which is a part facing the first slot, and being surrounded by a second inside wall and a second battery pack supporting surface.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a perspective view of a one-slot-type battery charger in accordance with the conventional art;

FIG. 1B is a cross-sectional side view of the one-slot-type battery charger shown in FIG. 1A;

FIG. 2A is a perspective view of a two-slot-type battery charger in accordance with the conventional art;

FIG. 2B is a cross-sectional side view of the two-slot-type battery charger shown in FIG. 2A;

FIG. 3 is a perspective view of a battery charger in accordance with the present invention;

FIG. 4 is an enlarged view of a part “A” of the battery charger shown in FIG. 3;

FIG. 5 is an enlarged view of a part “B” of the battery charger shown in FIG. 3;

FIG. 6 is a partial cutaway front perspective view of the battery charger shown in FIG. 3, with a reserve battery pack inserted therein;

FIG. 7 is an enlarged view of a part “C” of the battery charger shown in FIG. 6;

FIG. 8 is a partial cutaway rear perspective view of a battery charger in accordance with the present invention, with both a battery pack affixed to a mobile phone and a reserve battery pack inserted therein;

FIG. 9 is an enlarged view of a part “D” of the battery charger shown in FIG. 8;

FIG. 10 is a cross-sectional side view of a battery charger in accordance with the present invention; and

FIG. 11 is an enlarged view of a part “E” of the battery charger shown in FIG. 10.

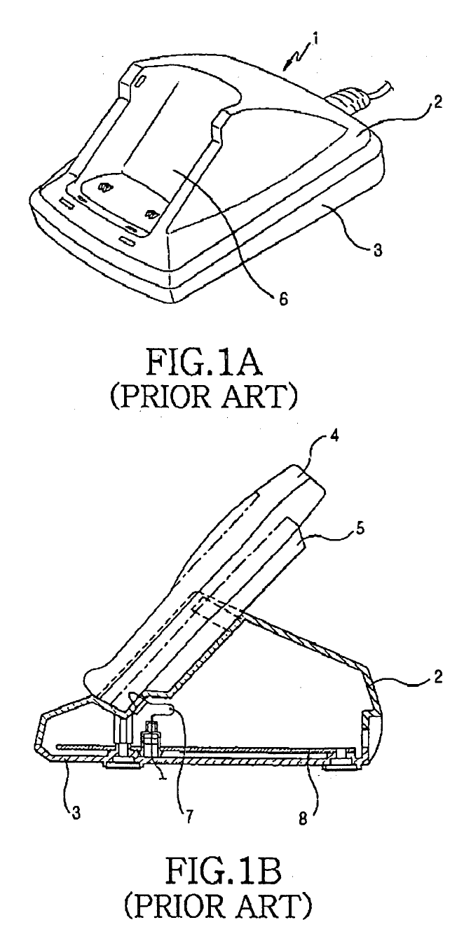

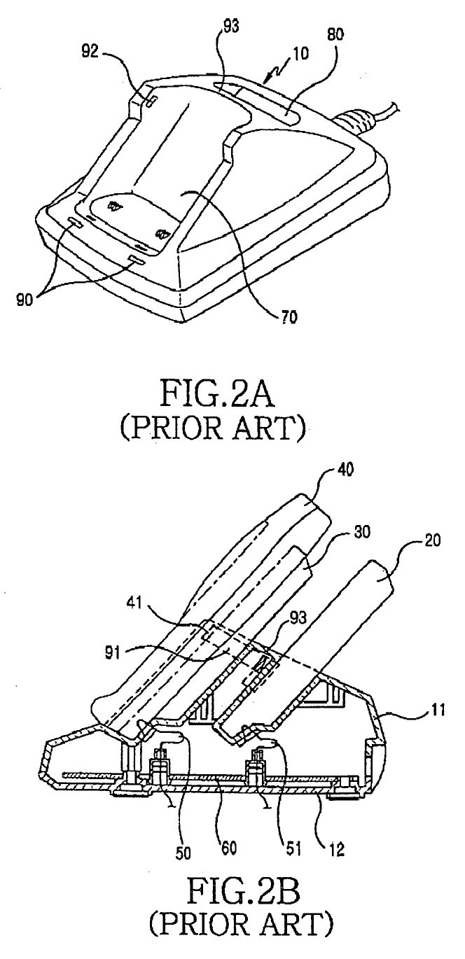

### DETAILED DESCRIPTION OF THE PREFERRED EMBODIMENTS

A detailed description of a battery charger for a mobile phone in accordance with a preferred embodiment of the present invention will be given below with reference to the accompanying drawings.

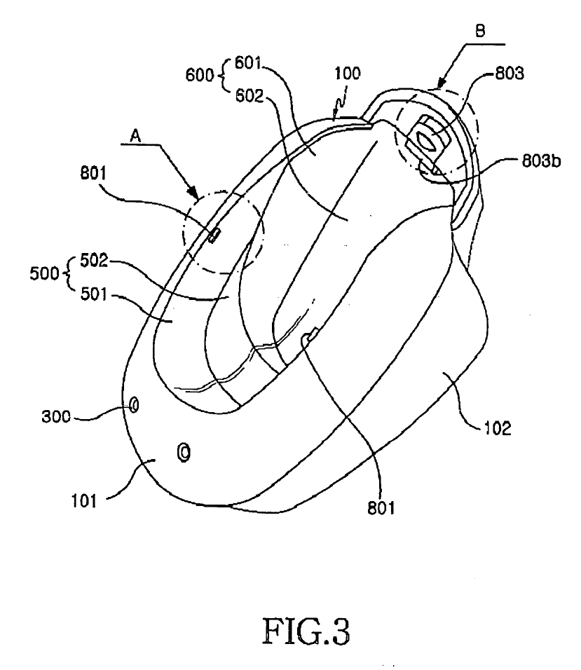

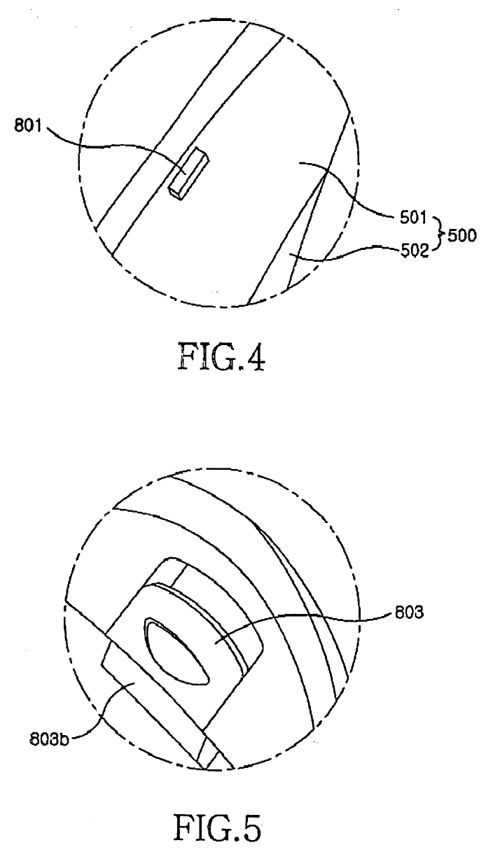

FIG. 3 is a perspective view of a battery charger for a mobile phone in accordance with the present invention. Referring to FIG. 3, a battery charger for a mobile phone 200 in accordance with the present invention has a body 100 being comprised of an upper case 101 and a lower case 102. Referring to FIGS. 4 to 11, the upper case 101 has a first slot 500 at the upper part thereof. The first slot 500 receives a battery pack 201 combined with the mobile phone 200 so as for the battery pack 201 to be charged therein.

The first slot 500 is opened at the front part thereof and is defined by a first inside wall 501 and a first battery pack-supporting surface 502. The upper case 101 further has a second slot 600 at the lower part thereof for receiving a reserve battery pack 202 separated from the mobile phone 200 so as for the reserve battery pack 202 to be charged therein. The second slot 600 is opened at the front part thereof, which is facing the first slot 500, and is defined by a second inside wall 601 and a second battery pack-supporting surface 602. The first slot 500 is larger than the second slot 600.

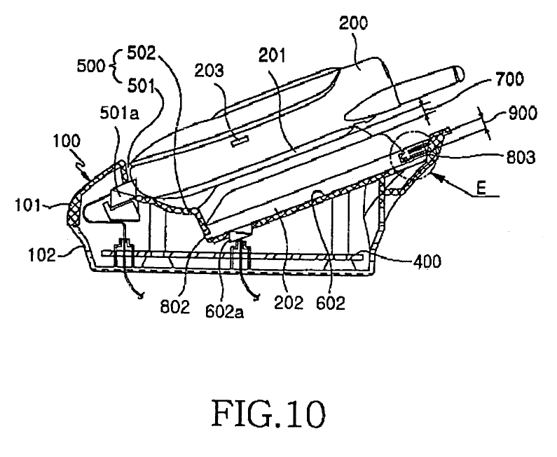

The first inside wall 501 has an interfacing connector 501a (FIG. 10) at a lower portion thereof for charging a battery pack 201 combined with the mobile phone 200 by being electrically connected with the mobile phone 200. The interfacing connector 501a (FIG. 10) is preferably a 16-pin or an 18-pin data communication cable.

The second battery pack-supporting surface 601 has a planar shape. The second battery pack-supporting surface 602 of the second slot 600 is provided with a charging terminal 602a (FIG. 10) for charging the reserve battery pack 202. Therefore, when the reserve battery pack 202 is received in the second slot 600, the charging terminal 602a comes into contact with the terminal provided on the back surface of the reserve battery pack 202, so that the reserve battery pack 202 is charged. Further, when the battery pack 201 combined with the mobile phone 200 and the reserve battery pack 202 separated from the mobile phone 200 are received in the first and second slots 500, 600, respectively, a first space 700 exists between the battery pack 201 and the battery pack 202, or between the first slot 500 and the second slot 600, so that the battery pack 201 and the reserve battery pack 202 are physically separated from each other by the first space 700. The first space 700 is an open space, so that there is no partition between the first and second slots 500, 600, and battery packs having different thickness can be received in the first and second slots and charged therein.

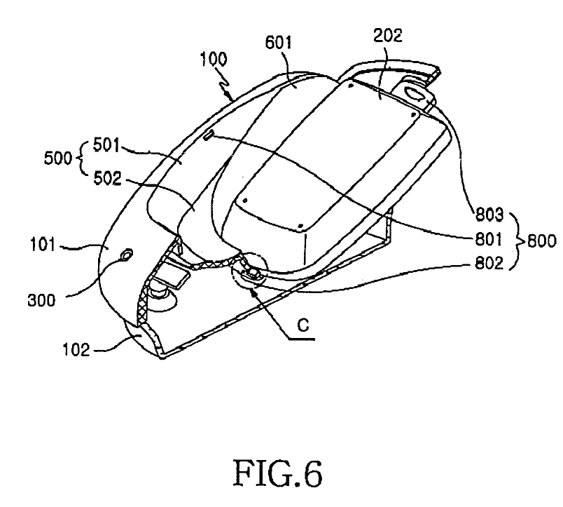

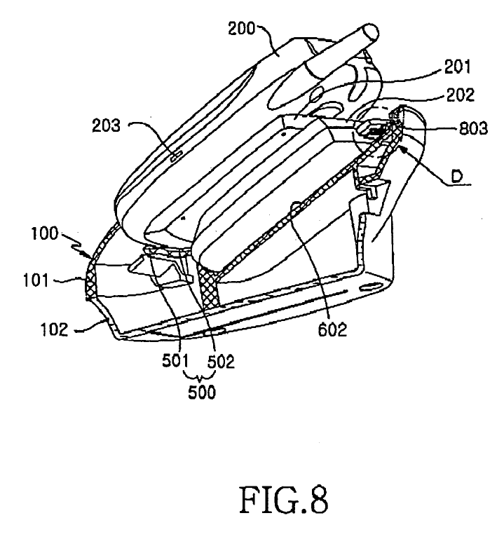

A locking device 800 (FIG. 6) comprising fixing protrusions 801, a sub-lock 802 and a main lock 803 is provided at respective portions of the first and second slots 500, 600 for fixing and releasing the battery packs 201, 202 into or from the first and second slots 500, 600. The fixing protrusions 801 are formed at the opposite upper portions of the first inside wall 501 so as to be combined with respective fixing grooves 203 (FIG. 8) formed at portions of the mobile phone 200 when a lower end portion of the mobile phone 200 comes into contact with the interfacing connector 501a (FIG. 10) formed at the lower portion of the first inside wall 501.

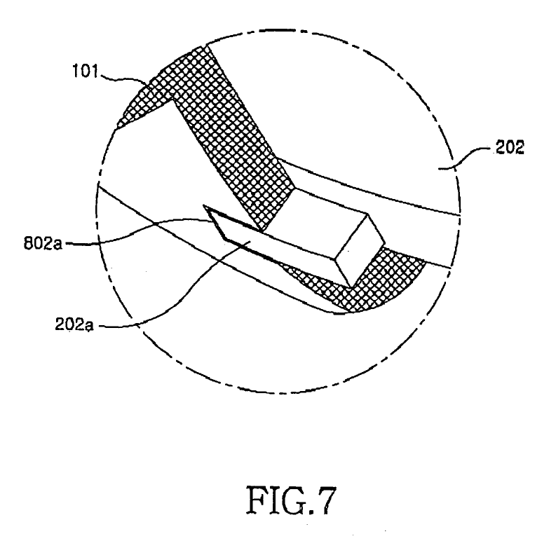

The sub-lock 802 is formed at a lower portion of the second battery pack supporting surface 602 so as to be combined with a lower end portion of the reserve battery pack 202 when the reserve battery pack 202 is arrived at the second battery pack supporting surface 202. The sub-lock 802 has a combining groove 802a (FIG. 7) to be combined with a combining protrusion 202a formed at the lower end of the reserve battery pack 202.

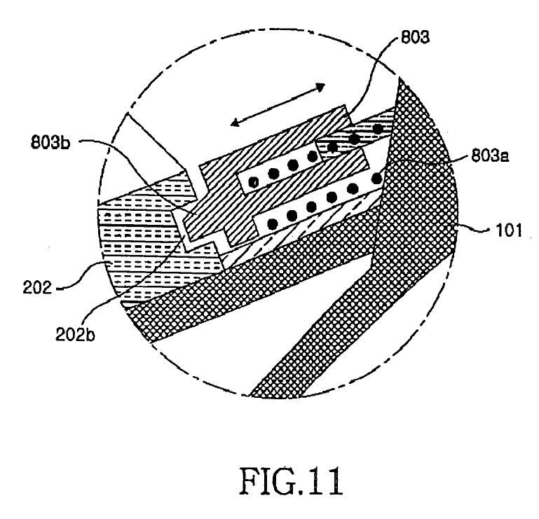

The main-lock 803 is provided at an upper portion of the second battery pack-supporting surface 602 so as to be combined with a locking groove 202b (FIG. 11) formed at an upper end portion of the reserve battery pack 202 as soon as the lower end portion of the reserve battery pack 202 comes into contact with the lower end portion of the second battery pack-supporting surface 602. In the main-lock 803, a coil spring 803a with a restoring force is provided, so that the main-lock 803 moves toward and combines with the locking groove 202b of the reserve battery pack 202 by the coil spring 803a. The main-lock 803 further has a second space 900 so as for the main-lock 803 to be able to operate therein to release the reserve battery pack 202 from the second battery pack-supporting surface 602 of the second slot 600. The main-lock 803 still further has a locking protrusion 803b (FIGS. 3, 5 and 11). The locking protrusion 803b either is inserted into or separates from the locking groove 202b of the reserve battery pack 202. The interfacing connector 501a and the charging terminal 602a are electrically connected with a printed circuit board 400 provided in the body 100 of the battery charger. The operation of the battery charger in accordance with the present invention will be described below with reference to FIGS. 3 to 11.

Referring to FIGS. 3 to 5, since the body 100 of the battery charger has the upper case 101 and the lower case 102, and the upper case 101 is provided with the first slot surrounded by the first inside wall 501 and the first battery pack-supporting surface 502, the mobile phone 200 combined with the battery pack 201 is received in the first slot 500 in such a manner that the back surface of the battery pack 201 comes into contact with the first battery pack supporting surface 501 of the first slot 500.

Referring to FIG. 4, when the mobile phone 200 is received into the first slot 500, the interfacing connector 501a formed at the lower end portion of the first inside surface 501 comes into contact with the terminal of the mobile phone 200, and the fixing protrusions 801 formed at both upper end portions of the first inside wall 501 are combined with the fixing grooves 203 formed at the body of the mobile phone 200, so that the mobile phone 200 is fixed into the first slot 500.

On the other hand, since the upper case 101 has the second slot 600 formed under the first slot 500, opened at the front surface facing the first slot 500, and defined by the second inside wall 601 and the second battery pack supporting surface 602, the reserve battery pack 202 slides along the second battery pack supporting surface 602 of the second slot 600 and safely arrives at the second battery pack supporting surface 602.

When the reserve battery pack 202 slides into the second slot 600, since the second battery pack supporting surface 602 has the charging terminal 602a at a portion thereof, the terminal (not shown) formed at the back surface of the reserve battery pack 202 comes into contact with the charging terminal 602a as soon as the reserve battery pack 202 arrives at the second battery pack-supporting surface 602.

Further at this time, with reference to FIGS. 6 and 7, since the second battery pack-supporting surface 602 is provided with the sub-lock 802 having the combining groove 802a at the lower end portion thereof, the combining protrusion 202a formed at the lower end of the reserve battery pack 202 is inserted into the combining groove 802 of the sub-lock.

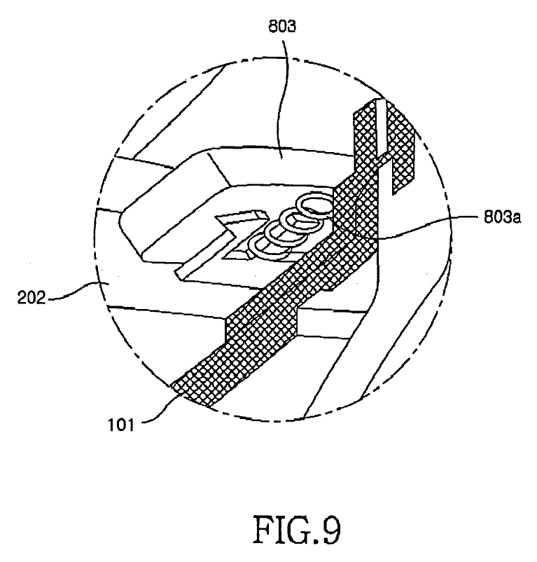

Referring to FIGS. 8 and 9, since the main-lock 803 having the coil spring 803a therein is provided at the upper portion of the second battery pack supporting surface 602 in such a manner that the main-lock 803 is pushed into the locking groove 202b formed at the upper end portion of the reserve battery pack 202 as soon as the reserve battery pack 202 arrives at the lower end portion of the second battery pack supporting surface 602, the main-lock 803 is combined with the reserve battery pack 202 by being pushed into the locking groove 202b of the reserve battery pack 202 when the reserve battery pack 202 is received in the second slot 600.

That is, the main-lock 803 binds the reserve battery pack 202 to the body 100 of the battery charger by the restoring force of the coil spring 803a.

At this time, with reference to FIGS. 10 and 11, the main-lock 803 binds the reserve battery pack 202 in such a manner that the locking protrusion 803b is pulled up by an external force, the reserve battery pack 202 slides into the second slot 600, and the locking protrusion 803b is inserted into the locking groove 202b of the reserve battery pack 202 by the restoring force of the coil spring 803a of the main-lock 803 as soon as the locking protrusion is released. As described above, since the locking device is provided to bind the battery pack to the battery charger, reserve battery packs having different widths can be charged using the second slots of the battery charger in accordance with the present invention.

As the battery packs 201 and 202 are received in the slots 500 and 600, respectively, the battery packs 201 and 202 are charged.

It is preferable that the upper case 101 has at least one lamp 300 indicating whether the charging operations of the battery packs 201, 202 are completed.

After the battery packs 201, 202 are completely charged, the battery packs 201, 202 are separated from the body 100 of the charger.

At this time, since the first space 700 interposes between the battery pack 201 combined with the mobile phone 200 and the reserve battery pack 202 separated from the mobile phone 200, the battery packs 201, 202 are more easily separated from the battery charger.

Further, the main lock 803 has the second space 900, the reserve battery pack 262 can be easily detached from the second battery pack supporting surface 602 by pulling up the main-lock 803.

Further, as long as an external force is not given to the main-lock 803, the battery pack 202 remains combined with the battery charger. But if an external force is applied to the main-lock 803 to pull up the main-lock 803, the locking protrusion 803b of the main-lock 803 is separated from the locking groove 202b of the reserve battery pack 202 and the reserve battery pack 202 can be released from the battery charger.

As described above, by opening the front part of the slots of the battery charger, the battery pack combined with the mobile phone and the reserve battery pack separated from the mobile phone can be simultaneously charged, fabrication of the battery charger becomes easier, and the size of the battery charger is reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A battery charger for a mobile phone, comprising:
a first slot having an opening at front and top parts thereof and surrounded by a first inside wall and a first battery pack supporting surface; and
a second slot having an opening at front and top parts thereof, wherein the front part of the opening of the second slot faces the opening of the first slot, and the second slot is surrounded by a second inside wall and a second battery pack supporting surface.

2. The battery charger as set forth in claim 1, wherein the first slot is larger than the second slot.

3. The battery charger as set forth in claim 1, wherein the first inside wall has an interfacing connector for electrically connecting to the mobile phone.

4. The battery charger as set forth in claim 1, wherein the second battery pack supporting surface is a planar surface, and has a charging terminal thereon.

5. The battery charger as set forth in claim 4, wherein the charging terminal comes into contact with a terminal formed at a back surface of a battery pack when the battery pack is received on the second battery pack-supporting surface.

6. The battery charger as set forth in claim 1, wherein a first space is provided between a battery pack received in the first slot and a reserve battery pack received in the second slot, so that the battery packs received in the first and second slots are physically separated from each other when the battery packs are received in the first and second slots, respectively.

7. The battery charger as set forth in claim 1, wherein the first slot has a plurality of fixing protrusions and the second slot has a main lock to fix and release battery packs to and from the first and second slots, respectively.

8. The battery charger as set forth in claim 7, wherein the fixing protrusions are formed at both upper end portions of the first inside wall for combining with fixing grooves formed on a body of the mobile phone when the interfacing connector formed at a lower portion of the first inside wall comes into contact with an electrical connection terminal of the mobile phone.

9. The battery charger as set forth in claim 7, wherein the battery charger further includes:
a sub-lock with a combining groove, which is provided at a lower portion of the second inside wall and combined with a combining protrusion formed at a lower end portion of a reserve battery pack when the reserve battery pack is received in the second battery pack supporting surface; wherein the main lock is provided at an upper portion of the second battery pack supporting surface of the battery charger and combines with a locking groove at an upper portion of the reserve battery pack when the reserve battery pack arrives at the second battery supporting surface, thereby binding the battery pack to the battery charger, and a coil spring is provided in the main lock for providing a restoring force to the main-lock so that the main lock moves toward the locking groove of the reserve battery pack.

10. The battery pack as set forth in claim 9, wherein the main lock further has a second space in which the main lock operates to release the reserve battery pack from the second battery pack supporting surface of the battery charger.
